(19) United States
(12) Patent Application Publication
(10) Pub. No.: US 2025/0184874 A1
(43) Pub. Date: Jun. 5, 2025

(54) ACTIVE SCANNING WITH EXCLUDED SSID LISTS

(71) Applicant: Silicon Laboratories Inc., Austin, TX (US)

(72) Inventor: Nitesh Kumar Shah, Bihar (IN)

(21) Appl. No.: 18/525,266

(22) Filed: Nov. 30, 2023

(51) Int. Cl. H04W 48/16; H04W 48/14; H04W 84/12

(52) U.S. Cl. CPC H04W 48/16; H04W 48/14; H04W 84/12

(57) ABSTRACT

A technique for reducing power consumption and latency in wireless communications includes reducing communications of redundant or unwanted information during a discovery operation of a wireless communications protocol. The technique includes an excluded identifier field in a probe request frame to instruct an access point to forgo sending a probe response frame or to reduce information included in a probe response frame. The technique reduces the number of probe response frames communicated over the air or total amount of information communicated during the discovery operation, thereby reducing power consumption and likelihood of collisions that would impact system performance.

### BACKGROUND

### Field of the Invention

This disclosure relates to communications systems in general, and more particularly to wireless communications systems.

### Description of the Related Art

In general, wireless local area network (WLAN) protocols (e.g., Wi-Fi® protocols, i.e., IEEE 802.11 protocols) are widely deployed across different consumer and electronics devices in home, life, and industrial applications. According to the Wi-Fi protocol, a station (e.g., a wireless communications device, a client radio, or a node) performs an active scan or a passive scan to discover details associated with nearby access points (e.g., a wireless communications device that allows other communications devices to join a local area network). An active scan includes the station transmitting a probe request frame (e.g., a broadcast probe request frame) in multiple channels and listening for a probe response frame from an access point. Under some circumstances, the station receives many probe response frames from nearby access points. Many of the probe response frames may include a Reduced Neighbor Report (RNR) element of neighboring access points, colocated access points, or a combination thereof. The same access point information may be received multiple times after decoding RNR elements of probe response frames received in either the same channel or other channels. In addition, an RNR element that includes information associated with multiple access points or multiple sets of access points increases the length of the probe response frame. The volume and length of probe response frames is directly related to power consumption associated with decoding the received probe response frames. Thus, those undesired probe response frames in the air waste channel bandwidth, as well as increase the latency in ongoing traffic for a set of synchronized stations (e.g., stations in a basic service set (BSS) identified by a Basic Service Set Identifier (BSSID)) present in those channels. The high number of probe response frames can cause collisions, which may result in the station not receiving some probe response frames. Accordingly, improved communications techniques are desired.

### SUMMARY OF EMBODIMENTS OF THE INVENTION

In an embodiment, a method for communications in a wireless network includes transmitting, by a first node, a probe request frame including a field including at least one identifier. Each identifier included in the field informs a corresponding access point to forgo transmission of any probe response frame in response to the probe request frame. The method may include including in the field, by the first node, an identifier of the corresponding access point in response to knowledge of the corresponding access point operating in a communications channel currently selected for scanning. The method may include forgoing transmission of the corresponding probe response frame, by the recipient of the probe request frame, in response to receiving the probe request frame and the identifier corresponding to the recipient of the probe request frame being included in the field. The probe request frame may include a second field. The second field may indicate at least one supported communications channel. A Reduced Neighbor Report element of a probe response frame transmitted by a recipient of the probe request frame may include only identifiers corresponding to access points that operate using the at least one supported communications channel. The second field may indicate at least one preferred communications channel. A reduced neighbor report of a probe response frame transmitted by a recipient of the probe request frame may include only identifiers corresponding to nodes that operate using the at least one preferred communications channel.

In at least one embodiment, a communications system includes a first node. The first node includes a layer of a communications protocol configured to generate a probe request frame including a field including at least one identifier. Each identifier included in the field informs a corresponding access point to forgo transmission of any probe response frame in response to the probe request frame. The first node includes a physical layer of the communications protocol configured to transmit the probe request frame. The communications system may include an access point including a second physical layer of the communications protocol configured to receive the probe request frame and a second layer of the communications protocol configured to determine whether to transmit a probe response frame in response to the probe request frame based on the field and an identifier corresponding to the access point. The second layer of the communications protocol may be further configured to forgo transmission of the probe response frame, by the access point, in response to receiving the probe request frame and the identifier corresponding to the access point being included in the field. The probe request frame may further include a second field. The second field may indicate at least one supported communications channel. A Reduced Neighbor Report element of the probe response frame transmitted by the access point may include only identifiers corresponding to access points that operate using the at least one supported communications channel. The second field may indicate at least one preferred communications channel and a Reduced Neighbor Report element of the probe response frame transmitted by the access point may include only identifiers corresponding to nodes that operate using the at least one preferred communications channel.

In at least one embodiment, a method for communicating in a wireless network includes receiving, by an access point, a probe request frame including a field including at least one identifier. Each identifier included in the field informs a corresponding access point to forgo transmission of any probe response frame in response to the probe request frame. The method includes determining whether to transmit a probe response frame in response to the probe request frame based on the field and an identifier corresponding to the access point. The method may include forgoing transmission of the probe response frame, by the access point, in response to receiving the probe request frame and the identifier corresponding to the access point being included in the field. The probe request frame may further include a second field, the second field indicating at least one supported communications channel. A Reduced Neighbor Report element of the probe response frame may include only identifiers corresponding to access points that operate using the at least one supported communications channel. The second field may indicate at least one preferred communications channel, and a Reduced Neighbor Report element of the probe response frame may include only identifiers corresponding to nodes that operate using the at least one preferred communications channel.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary wireless communications system implementing a WLAN communications protocol.

FIG. 2 illustrates the three non-overlapping radio frequency (RF) channels and associated sidebands of a WLAN communications protocol.

FIG. 3 illustrates a functional block diagram of an exemplary wireless communications receiver of FIG. 1.

FIG. 4 illustrates a functional block diagram of an exemplary wireless communications transmitter of FIG. 1.

FIG. 5 illustrates a functional block diagram of the exemplary software protocol stack executing on an exemplary wireless communications device of FIG. 1.

FIG. 6A illustrates exemplary fields of a probe request frame consistent with at least one embodiment of the invention.

FIG. 6B illustrates exemplary fields of a probe response frame consistent with at least one embodiment of the invention.

FIG. 7 illustrates information and control flows for responding to a probe request frame having an Excluded Service Set Identifier (SSID) List element consistent with at least one embodiment of the invention.

FIG. 8 illustrates information and control flows for responding to a probe request frame having various fields consistent with at least one embodiment of the invention.

The use of the same reference symbols in different drawings indicates similar or identical items.

### DETAILED DESCRIPTION

A technique for reducing power consumption and latency in wireless communications includes reducing communications of redundant information during a discovery operation of a wireless communications protocol. The technique includes the addition of an excluded identifier field in a probe request frame that instructs an access point to forgo sending a probe response frame or to reduce the information included in a probe response frame. As a result, the technique reduces the number of probe response frames or size of a probe response frame communicated over the air. The length of probe response frames may decrease due to removal of undesired access point information in an RNR element of the probe response frame. The reduction in probe response frame transmissions reduces the likelihood of collisions that would degrade system performance.

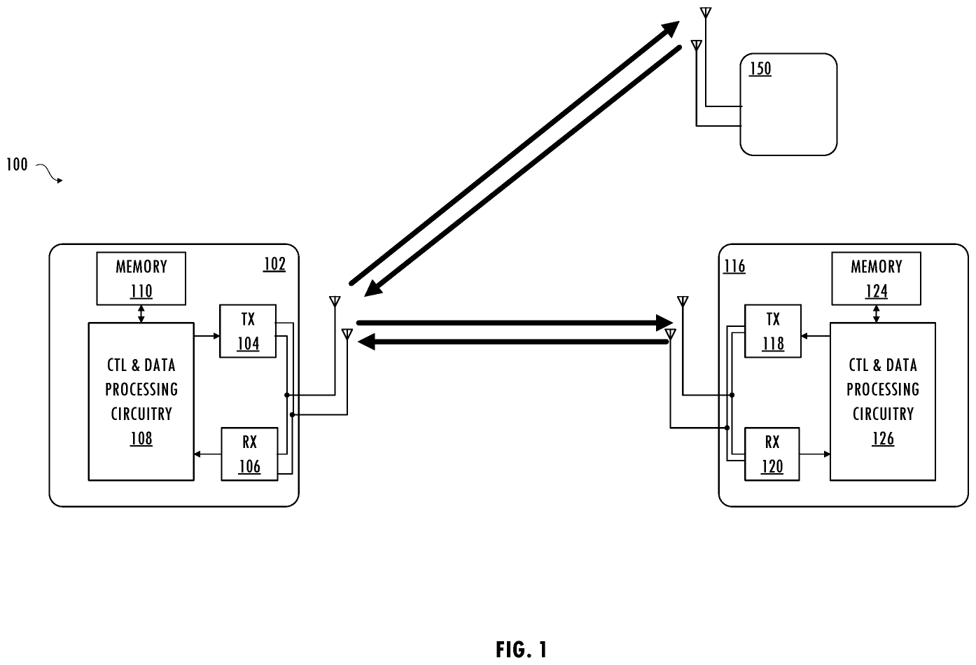

Referring to FIG. 1, in at least one embodiment, network 100 includes wireless communications device 102 and wireless communications device 116, which include wireless communications interfaces compliant with an IEEE 802.11 protocol for local area networking of devices (e.g., Wi-Fix). Network 100 operates in the 2.4 GHz frequency band for transmitting the frames over the air. Wireless communications device 102 includes transmitter 104, receiver 106, control & data processing circuitry 108, and memory 110. Wireless communications device 116 includes transmitter 118, receiver 120, control & data processing circuitry 126, and memory 124. Although wireless communications device 102 and wireless communications device 116 are illustrated as each including only one transmitter, one receiver, and two antennas, in other embodiments of network 100, wireless communications device 102 or wireless communications device 116 includes multiple transmitters, multiple receivers, additional antennas, or a single antenna with internal circuitry selection or radio frequency switches. Network 100 can communicate information using a predetermined wireless communications protocol, e.g., data using an IEEE standard 802.11 communications protocol. However, in other embodiments, network 100 can transmit and receive data compliant with other wireless communications protocols. In an embodiment of network 100, wireless communications device 102 is configured as a station and wireless communications device 116 is configured as an access point. In at least one embodiment of network 100, at least one additional access point (e.g., wireless communications device 150) is within the communications range of wireless communications device 102.

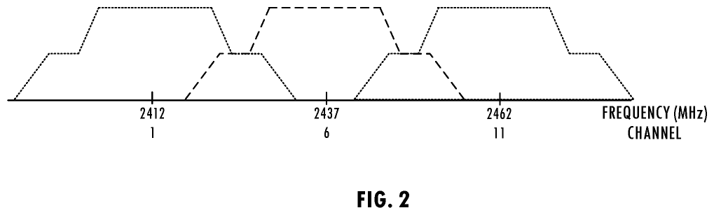

FIG. 2 illustrates three of fourteen channels of the 2.4 GHz band in a communications system compliant with an IEEE standard 802.11 communications protocol. Channels 1, 6, and 11, are non-overlapping channels that have respective center frequencies of 2412 MHz, 2437 MHz, and 2462 MHz. Each Wi-Fi channel has a 20 MHz bandwidth. Other channels may occur in the 5 GHz frequency band (e.g., channels 36-165) and the 6 GHz frequency band (e.g., channels 1-233).

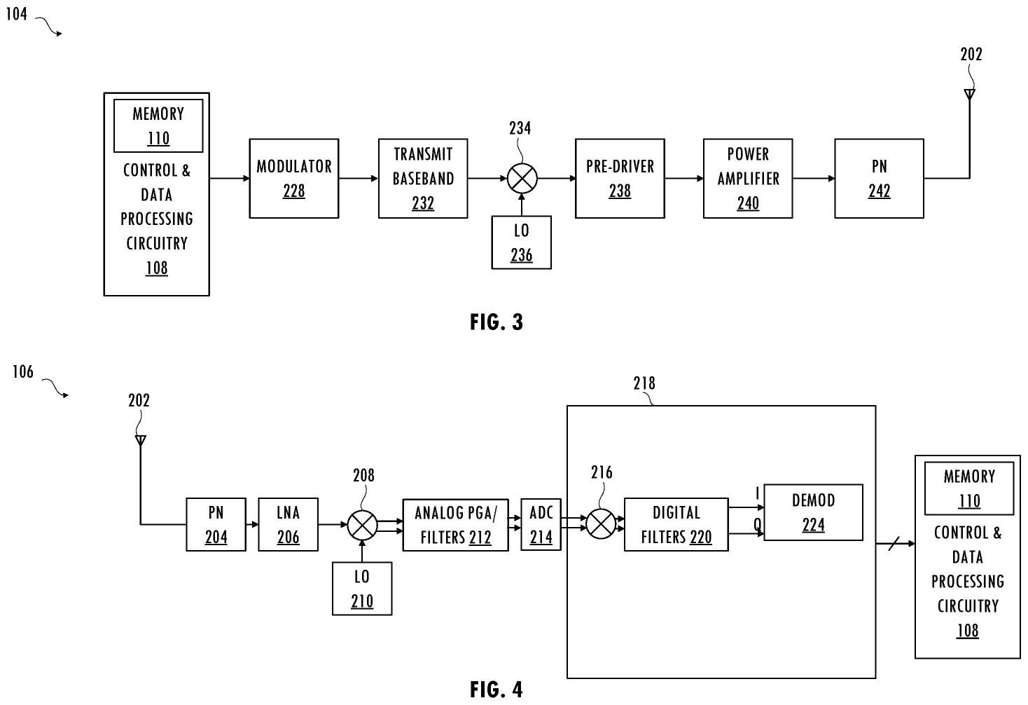

FIG. 3 illustrates an exemplary embodiment of transmitter 104 that may be included in a physical radio of wireless communications device 102 or wireless communications device 116 of FIG. 1. Control & data processing circuitry 108 of FIG. 3 may perform a variety of functions (e.g., logic, arithmetic, etc.). For example, data processing circuitry 108 executes a program, routine, or algorithm (whether in software, firmware, hardware, or a combination thereof) that performs desired control or data processing tasks consistent with a physical layer of a communications protocol and provides data to modulator 228. Modulator 228 applies a predetermined modulation scheme (e.g., phase-shift keying or quadrature amplitude modulation) to data for transmission and provides modulated data to transmit baseband circuit 232, which in an embodiment includes a digital-to-analog converter and analog programmable gain filters. Transmit baseband circuit 232 provides the baseband (or intermediate frequency (IF)) signal to frequency mixer 234, which performs frequency translation or shifting of the baseband signal using a reference or local oscillator (LO) signal provided by local oscillator 236. In at least one operational mode of transmitter 104, frequency mixer 234 translates the baseband signal centered at DC to a 2.4 GHz frequency band. Pre-driver 238 amplifies the signal generated by frequency mixer 234 to a level sufficient for power amplifier 240. Power amplifier 240 further amplifies the signal to provide a higher power signal sufficient to drive passive network 242 and antenna 202, which has a suitable gain and resonance frequency. Passive network 242 provides impedance matching, filtering, and electrostatic discharge protection with suitable Q factor, resonance frequency, and bandwidth.

FIG. 4 illustrates an exemplary embodiment of receiver 106 that may be included in a radio of the wireless communications devices described above. Antenna 202 provides a radio frequency (RF) signal to passive network 204, which provides impedance matching, filtering, and electrostatic discharge protection. Passive network 204 is coupled to low-noise amplifier 206, which amplifies the RF signal without substantial degradation to the signal-to-noise ratio and provides the amplified RF signal to frequency mixer 208. Frequency mixer 208 performs frequency translation or shifting of the RF signal using a reference or local oscillator signal provided by local oscillator 210. For example, in at least one operational mode of receiver 106, frequency mixer 208 translates the RF signal from a 2.4 GHz frequency band to baseband frequencies centered at DC (i.e., zero-intermediate frequency (ZIF) in a ZIF mode of operation). In another operational mode, receiver 106 is configured as a low-intermediate frequency (LIF) receiver (i.e., in a LIF mode of operation) and frequency mixer 208 translates the RF signal to a low-intermediate frequency (e.g., 100-200 kHz) to reduce or eliminate DC offset and 1/f noise problems of ZIF receivers.

Frequency mixer 208 provides the translated output signal as a set of two signals, an in-phase (I) signal and a quadrature (Q) signal. The I and Q signals are analog time-domain signals. In at least one embodiment of receiver 106, the analog programmable gain amplifier and filters 212 provide amplified and filtered versions of the I and Q signals to analog-to-digital converter (ADC) 214, which converts those versions of the I and Q signals to digital I and Q signals (i.e., I and Q samples). Exemplary embodiments of ADC 214 use a variety of signal conversion techniques (e.g., delta-sigma (i.e., sigma-delta) analog-to-digital conversion). ADC 214 provides the digital I and Q signals to signal processing circuitry 218. In general, signal processing circuitry 218 performs digital signal processing (e.g., frequency translation (e.g., using digital mixer 216), filtering (e.g., using digital filters 220), demodulation, or signal correction) of the digital I and Q signals. In at least one embodiment, signal processing circuitry 218 includes demodulator 224, which recovers or extracts information from digital I and Q signals (e.g., data signals, that were modulated using phase-shift keying or quadrature amplitude modulation by modulator 228 of transmitter 104 of FIG. 3 and provided to antenna 102 as RF signals).

Referring back to FIG. 4, control & data processing circuitry 108 may perform a variety of functions (e.g., logic, arithmetic, etc.). For example, control & data processing circuitry 108 may use the demodulated data in a program, routine, or algorithm (whether in software, firmware, hardware, or a combination thereof) to perform desired control or data processing tasks. In at least one embodiment, control & data processing circuitry 108, which includes memory 110, controls other circuitry, sub-system, or systems (not shown). In an embodiment, control & data processing circuitry 108 implements a data link layer of the communications protocol that includes a state machine, defines state transitions, defines packet formats, performs scheduling, performs radio control, and provides link-layer decryption consistent with at least one wireless communications protocol. Transmitter 104 of FIG. 3 and receiver 106 of FIG. 4 are illustrative only and may vary with the communications protocol implemented by network 100 of FIG. 1.

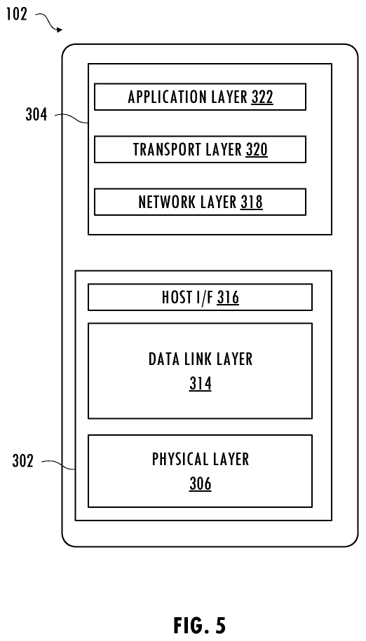

Referring to FIGS. 1 and 5, in an embodiment, data processing circuit 108 includes separate integrated circuits for controller 302 and host 304. In some embodiments, wireless communications device 102 incorporates functionality of controller 302 and host 304 in a single integrated circuit device. Controller 302 executes instructions to implement portions of the WLAN protocol stack. For example, controller 302 implements physical layer 306 which is software that interacts with the RF transceiver (e.g., the transmitter and receiver described above). Data link layer 314 interfaces directly to physical layer 306 to handle transmission and reception of associated signals. In at least one embodiment, data link layer 314 of controller 302 communicates with host 304 via host interface 316. Host 304 implements upper layers of the communications protocol stacks (e.g., network layer 318, transport layer 320, and application layer 322, which implements the upper layers for WLAN protocol stack). In other embodiments, the layers of the software protocol stack have different distributions between controller 302 and host 304 or are completely implemented using controller 302.

Active scanning by wireless communications device 102 is restricted in some frequency bands and regulatory domains. To actively scan, wireless communications device 102 transmits a probe request frame including a wildcard SSID, a desired SSID, or one or more short SSID list elements, consistent with the IEEE 802.11 standard communications protocol. Wireless communications device 116 communicates a probe response frame that may include a Reduced Neighbor Report (RNR) element that contains information on neighboring access points, colocated access points or a combination thereof. If an SSID in the probe request frame matches any of the SSIDs of the members of the multiple BSSID set, then an access point corresponding to the transmitted BSSID sends the probe response frame. An access point operating the 6 GHz frequency band may send an unsolicited broadcast probe response frame.

When wireless communications device 102 performs active scan in multiple channels, it may send broadcast probe request frames and may receive many probe response frames from various access points. Many of the probe response frames may include an RNR element of the neighboring access points or colocated access points. Thus, wireless communications device 102 may receive the same access point information multiple times after decoding RNR elements of each probe response frame received in either the same channel or in other channels. In addition, an increase in information in an RNR element for multiple BSS increases the length of the probe response frame.

The probe response frames may include redundant information or may be undesired and thus can waste channel bandwidth. In addition, some of those probe response frames may not be received by a soliciting station due to collisions. Those circumstances can increase latency and power consumption and can degrade performance of the wireless communications system. Although the IEEE 802.11 standard communications protocol limits usage of broadcast probe response frames to minimize the number of probe response frames transmitted by a single access point, in some cases, access point information might already be present in wireless communications device 102 after receiving a probe response frame that included an RNR element with that access point information.

A technique for reducing power consumption and latency in wireless communications includes reducing communications of redundant information during a discovery operation of a wireless communications protocol. The technique includes a new information element in the probe request frame that indicates which access points need not send a probe response frame in response to a probe request frame received from a nearby station. In at least one embodiment, the probe request frame also includes a Supported Channels element or a Preferred AP Channels element. The recipient access point includes in the RNR element of a probe response frame only information for access points that operate in channels listed in the Supported Channels element or Preferred AP Channels element. If the probe request frame includes the Supported Channels element and the Preferred AP Channels element, then the access point gives the Preferred AP Channels element preference and includes in the RNR element of a probe response frame only information for access points that operate in the channels listed in the Preferred AP Channels element. If the access point does not support the Preferred AP Channels element, then the access point shall include in the RNR element of a probe response frame only the information for access points that operate in the channels listed in the Supported Channels element. In an embodiment, a probe request frame includes an Excluded SSID List element, an Excluded Short SSID List element, Supported Channels element, and Preferred AP Channels element. These techniques are applicable for all frequency bands (e.g., 2 GHZ, 5 GHZ, 6 GHZ, and any other frequency bands) that are being used by the wireless device.

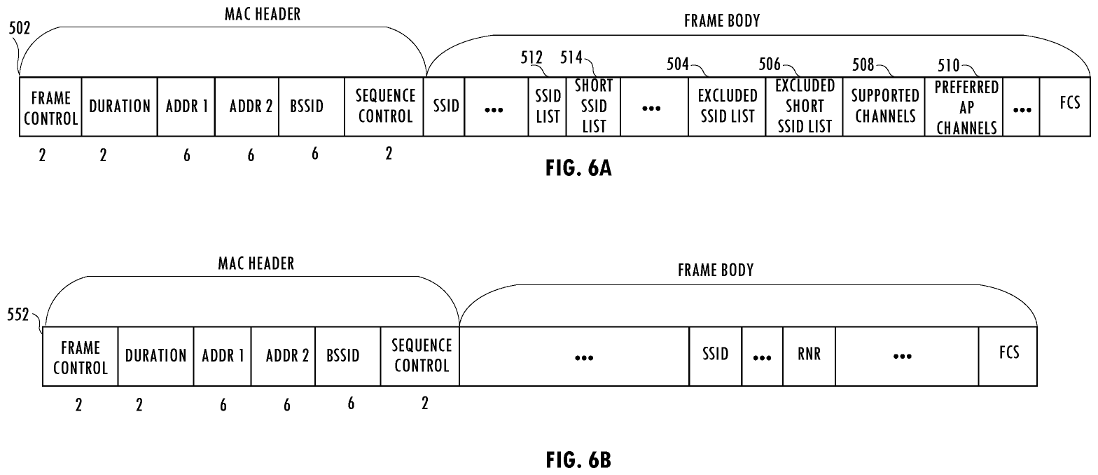

FIG. 6A illustrates an exemplary format of a probe request frame consistent with at least one embodiment of an active scanning technique. In at least one embodiment, probe request frame 502 includes a MAC header and a frame body. In at least one embodiment, the probe request frame includes SSID List element 512 or Short SSID List element 514 to list at least one SSID corresponding to an access point for which the station is requesting information. In addition, the probe request frame includes Excluded SSID List element 504, which specifies a list of SSIDs associated with any BSSs that are blacklisted by the station transmitting the probe request frame (i.e., in which the station transmitting the probe request frame is not interested in soliciting a probe response, e.g., disconnected access points, access points added to a blacklist by a user, etc.) during scan. In an embodiment, Excluded SSID List element 504 has a unique element ID but uses the same format as a conventional SSID List element consistent with the IEEE 802.11 standard communications protocol. In an embodiment, Excluded Short SSID List element 506 has a unique element identifier but uses the same format as a conventional Short SSID List element consistent with the IEEE 802.11 standard communications protocol. The Excluded SSID List element contains the SSID of the access point (e.g., 32 octets in length) and the Excluded Short SSID List element contains the short SSID of the access point (e.g., 4 octets in length). The station will include at least one SSID in Excluded SSID List element 504 or Excluded Short SSID List element 506 of a probe request frame if an access point is blacklisted by the station, the station already has the information for the access point (e.g., by decoding the information from an RNR element received from another access point) and does not want to receive that information again, or other reason.

In at least one embodiment, a station includes Excluded SSID List element 504 or Excluded Short SSID List element 506 in probe request frame 502 if the station has at least one SSID for which it does not want to receive a probe response frame, and it does not know the BSS of an access point that is operating in the current scan channel for which the station does not want to receive a probe response frame. In an embodiment, the station may not include the SSID in an Excluded SSID List element or Excluded Short SSID List element if the station knows that the access point associated with the SSID is not operating in the current scan channel. Thus, the SSID in Excluded SSID List Element 504 or Excluded Short SSID List element 506 may vary for each scan channel. In an embodiment, the station shall not specify the same SSID in the SSID List Element, which indicates that the station wants this information, and Excluded SSID List Element 504 to prevent contradictory instructions to an access point receiving the probe request frame. In an embodiment, the station does not list the same SSID in the Short SSID List element and Excluded Short SSID List element to prevent contradictory instructions to an access point receiving the probe request frame.

In at least one embodiment, wireless communications device 116 and wireless communications device 150 of FIG. 1 are access points that send probe response frames consistent with the format of probe response frame 552 of FIG. 6B. The access points do not include in, or removes from, the RNR element any information associated with any reported access points that have an SSID matching an SSID in Excluded SSID List Element 504 or Excluded Short SSID List element 506.

In an embodiment, if the access point determines whether it is an access point having an SSID that matches an SSID present in Excluded SSID List element 504 or Short Excluded SSID List element 506 and whether to send a probe response frame. For example, if access point AP1 is a member of a multiple BSSID set, and is a transmitted BSSID and its SSID matches an SSID present in Excluded SSID List element 504 or Short Excluded SSID List element 506, then, if access point AP1 receives a probe request frame including SSID List element 512 or Short SSID List element 514 listing an SSID that matches the SSID of any of the non-transmitted BSSID access points that are a member of the same multiple BSSID set, then access point AP1 sends a probe response frame. Otherwise, access point AP1 does not send a probe response frame. However, if access point AP1 is a member of a multiple BSSID set, and is a non-transmitted BSSID, then, another access point that is a member of the multiple BSSID (e.g., access point AP2) sends a probe response frame. Access point AP2 of the multiple BSSID corresponds to a transmitted BSSID and will not include the information associated with access point AP1, corresponding to a non-transmitted BSSID, in the RNR element of a unicast probe response frame but can include that information associated with access point AP1 in the multiple BSSID element of the unicast probe response frame. Access point AP2 of the multiple BSSID corresponds to a transmitted BSSID and includes the information associated with access point AP1, corresponding to a non-transmitted BSSID, in either the RNR or the multiple BSSID element of a broadcast probe response frame.

Referring to FIGS. 6A, and 6B, in at least one embodiment, a station includes Supported Channels element 508 in a probe request frame transmitted by the station. In response to receiving the probe request frame, an access point sends a probe response frame that includes an RNR element that contains information for only those access points that are operating in the channels indicated in Supported Channels element 508, thereby reducing the length of probe response frame 552 as compared to a probe response consistent with conventional techniques. Thus, the station receives only information for those access points that are operating on the channels that are supported by the station.

In at least one embodiment, a station includes Preferred AP Channels element 510 in a probe request frame transmitted by the station to indicate that the station wants to receive a probe response frame including only information for those access points that are operating in selected channels, rather than information for access points operating in any of the channels present in Supported Channels element 508. In an embodiment, Preferred AP Channels element 510 has a unique element identifier and has the same format as a conventional Supported Channels element. In an embodiment, the station does not scan all channels present in Preferred AP Channels element 510 but is still able to receive a probe response frame including a list of the access points operating in channels present in Preferred AP Channels element 510 without the station scanning those channels.

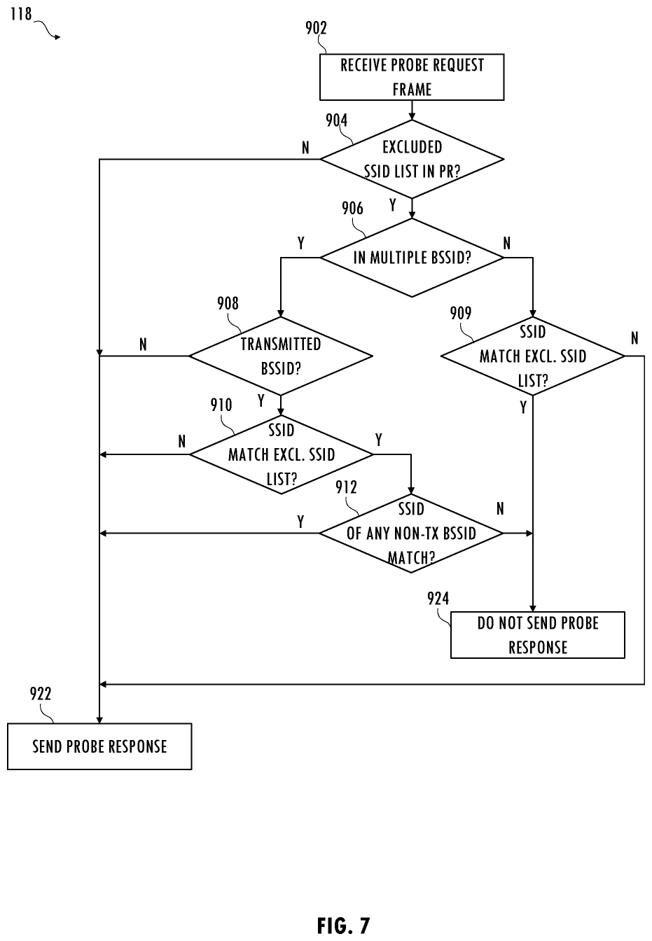

Referring to FIGS. 1 and 7, in at least one embodiment of network 100, an access point (e.g., wireless communications device 116) receives a probe request frame from a station (e.g., wireless communications device 102) (902). The access point (e.g., a Medium Access Control (MAC) layer of the communications protocol stack executing on wireless communications device 116) determines whether an Excluded SSID List element or an Excluded Short SSID List element is included in the received probe request frame (904). If an Excluded SSID List element or Excluded Short SSID List element is not present in the received probe request frame, then the access point sends a probe response frame consistent with the IEEE 802.11 standard communications protocol (922). If an Excluded SSID List element or an Excluded Short SSID List element is present in the received probe request frame, then the access point determines whether the SSID of the access point matches an SSID of a member of a multiple BSSID set (906). If an Excluded SSID List element or Excluded Short SSID List element is present in the received probe request frame (904) and the access point determines that the SSID of the access point does not match an SSID of a member of a multiple BSSID set (906), then the access point determines whether the SSID of the access point matches an SSID included in the Excluded SSID List element or the Excluded Short SSID List element (909). If the SSID of the access point matches an SSID included in the Excluded SSID List element or the Excluded Short SSID List element (909), then the access point does not send a probe response frame (924). If the SSID of the access point does not match an SSID included in the Excluded SSID List element or the Excluded Short SSID List element (909), then the access point sends a probe response consistent with the communications protocol (922).

If an Excluded SSID List element or an Excluded Short SSID List element is present in the received probe request frame (904) and the access point determines that the SSID of the access point matches an SSID of a member of a multiple BSSID set (906), then the access point determines whether the access point corresponds to a transmitted BSSID (908). If the access point does not correspond to a transmitted BSSID (908), then the access point sends a probe response consistent with the communications protocol (922). If the access point corresponds to a transmitted BSSID (908), then the access point determines whether the SSID of the access point matches an SSID included in the Excluded SSID List element or the Excluded Short SSID List element (910). If the access point corresponds to a transmitted BSSID (908) and the SSID of the access point matches an SSID included in the Excluded SSID List element or the Excluded Short SSID List element (910), then the access point, which corresponds to the transmitted BSSID, sends a probe response frame (922) only if the SSID corresponding to the transmitted BSSID access point does not match an SSID included in the Excluded SSID List element or the Excluded Short SSID List element. In an embodiment, for unicast probe response frames, an access point does not include information for a non-transmitted BSSID in the RNR element but may include that information in a multiple BSSID element. In an embodiment, for broadcast probe response frames, an access point includes information for a non-transmitted BSSID in either the RNR element or the multiple BSSID element.

If the access point is a member of a multiple BSSID set (906) and the BSSID is a transmitted BSSID (908), then wireless communications device determines whether the SSID of the access point matches an SSID included in the Excluded SSID List element or the Excluded Short SSID List element (910). The SSID of the access point matches an SSID included in the Excluded SSID List element or the Excluded Short SSID List element (910), then the access point, which corresponds to the transmitted BSSID, determines whether the SSID List element or the Short SSID List element includes an SSID corresponding to any access point that is a member of the same multiple BSSID and is a non-transmitted BSSID (912). If the SSID List element or the Short SSID List element includes an SSID corresponding to an access point that is a member of the same multiple BSSID and is a non-transmitted BSSID (912), then the access point sends a probe response frame (922) since the station requested this information for the non-transmitted BSSID in the probe request frame and will not receive the information in a probe response from the non-transmitted BSSID. Otherwise, (i.e., the SSID List element or the Short SSID List element does not include an SSID corresponding to an access point that is a member of the same multiple BSSID and is a non-transmitted BSSID (912)), the access point does not send the probe response frame (924).

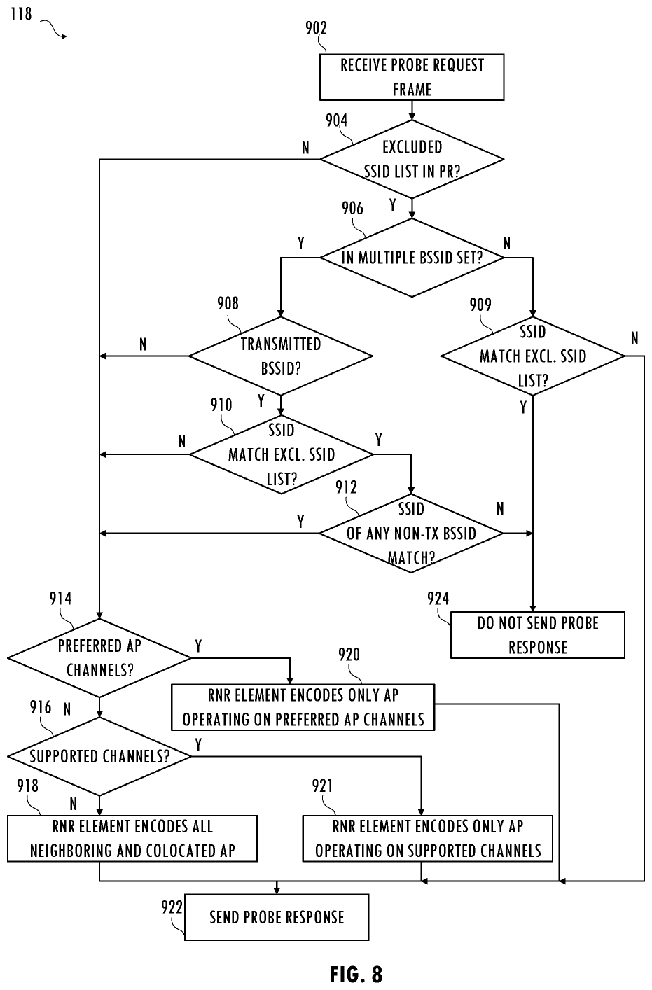

Referring to FIGS. 1 and 8, in at least one embodiment of network 100, the probe request frame received by the access point includes a Supported Channels element or a Preferred Channels element in addition to the Excluded SSID List element and the Excluded Short SSID List element. Accordingly, before sending a probe response frame, the access point determines whether a Preferred AP Channels element is included in the probe request frame (914) or a Supported Channels element is included in the probe request frame (916). If the Preferred AP Channels element is included in the probe request frame (914), then the access point encodes only information associated with access points operating in the channels identified in the Preferred AP Channels element (920), thereby reducing the length of the probe response frame. If the Preferred AP Channels element is not included in the probe request frame, but the Supported Channels element is included in the probe request frame (916), then the access point encodes only information associated with access points operating in the channels identified in the Supported Channels element (921), thereby reducing the length of the probe response. If the probe request frame does not include a Preferred AP Channels element or a Supported Channels element, then the access point encodes in the RNR element information for all neighboring and colocated access points (918). In an embodiment of network 100, stations transmit probe request frames that may include only a Preferred AP Channels element or a Supported Channels element but not an Excluded SSID List element or an Excluded Short SSID List element and steps 904, 906, 908, 909, 910, 912, and 924 are omitted.

Thus, techniques for reducing the number of probe response frames and the length of probe response frames have been described. A reduction in the number or length of probe responses frames reduces the amount of power consumed by processing probe response frames and reduces channel wastage due to unwanted response frames, which reduces latency attributable to packet collision. The techniques may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a magnetic, optical, or electronic storage medium.

The description of the invention set forth herein is illustrative and is not intended to limit the scope of the invention as set forth in the following claims. For example, while the invention has been described in an embodiment in which a WLAN (IEEE 802.11 b/g/n) communications protocol is used, one of skill in the art will appreciate that the teachings herein can be utilized with other wireless communications protocols that use communications similar to a probe request frame and a probe response frame described above. The terms “first,” “second,” “third,” and so forth, as used in the claims, unless otherwise clear by context, is to distinguish between different items in the claims and does not otherwise indicate or imply any order in time, location, or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for communicating in a wireless network, the method comprising:
transmitting, by a first node, a probe request frame including a field including at least one identifier, each identifier included in the field informs a corresponding access point to forgo transmission of any probe response frame in response to the probe request frame.

2. The method as recited in claim 1 further comprising:
including in the field, by the first node, an identifier of the corresponding access point in response to knowledge of the corresponding access point operating in a communications channel currently selected for scanning.

3. The method as recited in claim 1 further comprising:
determining, by a recipient of the probe request frame, whether to transmit a corresponding probe response frame based on whether an identifier corresponding to the recipient of the probe request frame is included in the field.

4. The method as recited in claim 3 further comprising:
forgoing transmission of the corresponding probe response frame, by the recipient of the probe request frame, in response to receiving the probe request frame and the identifier corresponding to the recipient of the probe request frame being included in the field.

5. The method as recited in claim 3 further comprising:
transmitting, by the recipient of the probe request frame, the corresponding probe response frame in response to receiving the probe request frame and the identifier corresponding to the recipient of the probe request frame being absent from the field.

6. The method as recited in claim 1 wherein the probe request frame further includes a second field, the second field indicating at least one supported communications channel.

7. The method as recited in claim 6 wherein a Reduced Neighbor Report element of a probe response frame transmitted by a recipient of the probe request frame includes only identifiers corresponding to access points that operate using the at least one supported communications channel.

8. The method as recited in claim 1 wherein the probe request frame further includes a second field, the second field indicating at least one preferred communications channel.

9. The method as recited in claim 8 wherein a Reduced Neighbor Report element of a probe response frame transmitted by a recipient of the probe request frame includes only identifiers corresponding to access points that operate using the at least one preferred communications channel.

10. The method as recited in claim 8 wherein a Reduced Neighbor Report element of a probe response frame transmitted by a recipient of the probe request frame includes only identifiers corresponding to access points that are not included in the field.

11. A communications system comprising:
a first node comprising:
a layer of a communications protocol configured to generate a probe request frame including a field including at least one identifier, each identifier included in the field informs a corresponding access point to forgo transmission of any probe response frame in response to the probe request frame; and
a physical layer of the communications protocol configured to transmit the probe request frame.

12. The communications system as recited in claim 11 further comprising:
an access point comprising:
a second physical layer of the communications protocol configured to receive the probe request frame; and
a second layer of the communications protocol configured to determine whether to transmit a probe response frame in response to the probe request frame based on the field and an identifier corresponding to the access point.

13. The communications system as recited in claim 12 wherein the second layer of the communications protocol is further configured to forgo transmission of the probe response frame, by the access point, in response to receiving the probe request frame and the identifier corresponding to the access point being included in the field.

14. The communications system as recited in claim 12
wherein the probe request frame further includes a second field, the second field indicating at least one supported communications channel, and
wherein a Reduced Neighbor Report element of the probe response frame transmitted by the access point includes only identifiers corresponding to access points that operate using the at least one supported communications channel.

15. The communications system as recited in claim 12
wherein the probe request frame further includes a second field, the second field indicating at least one preferred communications channel, and
wherein a Reduced Neighbor Report element of the probe response frame transmitted by the access point includes only identifiers corresponding to access points that operate using the at least one preferred communications channel.

16. A method for communicating in a wireless network, the method comprising:
receiving, by an access point, a probe request frame including a field including at least one identifier, each identifier included in the field informs a corresponding access point to forgo transmission of any probe response frame in response to the probe request frame; and
determining whether to transmit a probe response frame in response to the probe request frame based on the field and an identifier corresponding to the access point.

17. The method as recited in claim 16 further comprising:
forgoing transmission of the probe response frame, by the access point, in response to receiving the probe request frame and the identifier corresponding to the access point being included in the field.

18. The method as recited in claim 16 further comprising:
transmitting, by the access point, the probe response frame in response to receiving the probe request frame and the identifier corresponding to the access point being absent from the field.

19. The method as recited in claim 16
wherein the probe request frame further includes a second field, the second field indicating at least one supported communications channel, and
wherein a Reduced Neighbor Report element of the probe response frame includes only identifiers corresponding to access points that operate using the at least one supported communications channel.

20. The method as recited in claim 16
wherein the probe request frame further includes a second field, the second field indicating at least one preferred communications channel, and
wherein a Reduced Neighbor Report element of the probe response frame includes only identifiers corresponding to access points that operate using the at least one preferred communications channel.
